(19) United States
(12) Patent Application Publication
(10) Pub. No.: US 2017/0041789 A1
(43) Pub. Date: Feb. 9, 2017

(54) WEARABLE AUTHENTICATION

(71) Applicant: HEWLETT-PACKARD DEVELOPMENT COMPANY, L.P., HOUSTON, TX (US)

(72) Inventors: JAMES ROBERT WALDRON, HOUSTON, TX (US); VALENTIN POPESCU, HOUSTON, TX (US); CHRISTOPHER CHARLES MOHRMAN, HOUSTON, TX (US)

(21) Appl. No.: 15/305,312

(22) PCT Filed: May 13, 2014
(86) PCT No.: PCT/US2014/037926

§ 371 Date: Oct. 19, 2016

(51) Int. Cl. H04W 12/06; G06K 19/07; H04L 29/06

(52) U.S. Cl. CPC H04W 12/06; H04L 63/0853; H04L 63/0861; H04L 63/083; G06K 19/0716; G06K 19/0723

(57) ABSTRACT

A wearable authentication device including a wireless receiver and a module to store information indicating authentication has been established by first device.

### BACKGROUND

Security tokens are used to prove ones identity electronically. One example of a security token is Radio Frequency identification (RFID) tags which are widely used in identification badges, replacing magnetic stripe cards. These badges can be held within a certain distance of the reader to authenticate the holder. RFID tags can also be placed on vehicles which can be read at a distance, to allow entrance to controlled areas without having to stop the vehicle and present a card or enter an access code.

### BRIEF DESCRIPTION OF THE DRAWINGS

Some examples of the present disclosure are described with respect to the following figures:

FIG. 1 is a block diagram of a wearable authentication device cording to an example implementation;

FIG. 2 is a block diagram of a wearable authentication device according to an example implementation;

FIG. 3 is a flow diagram of a method of authenticating devices from a wearable according to an example implementation; and

FIG. 4 is a flow diagram of a method of authenticating devices from a wearable according to an example implementation.

### DETAILED DESCRIPTION

The RFID tags can include authentication information used to authenticate a user to a device. However an RFID tag does not detect whether the user that was assigned the badge with the RFID tag is the user still in position of the identification badge. The information on an RFID tag may be static thus if the RFID tag was used by someone other than the user that it was assigned to the system reading the RFID tag wound not know that a user other than the assigned user was using the RFID tag. The RFID tag also does not receive information that the user has authenticated to a system such that it cannot authenticate a user that was assigned the RFID tag. A wearable authentication device can receive information indicating authentication and also maintain authentication as long as the user continues to wear the wearable authentication device. The wearable authentication device can be used so that a user does not have to continue to enter their authentication information into a computer system such as a password every time they want to use the system.

In one implementation, a wearable authentication device can include a wireless receiver and a module to store information indicating authentication has been established by first device. A wireless transmitter can send information to a second device establishing authentication.

In another implementation, a wearable authentication device can include a wireless receiver and a module to store information indicating authentication has been established by first device. A sensor can determine that the wearable authentication device is being worn.

In another implementation, a method of authenticating a computing device can include receiving by a wearable authentication device information from a first device indicating the first device has authenticated a user with first authentication information. The method can store the information from the first device and transmit second authentication information to a second device authenticating the user to the second device when the information from the first device is stored.

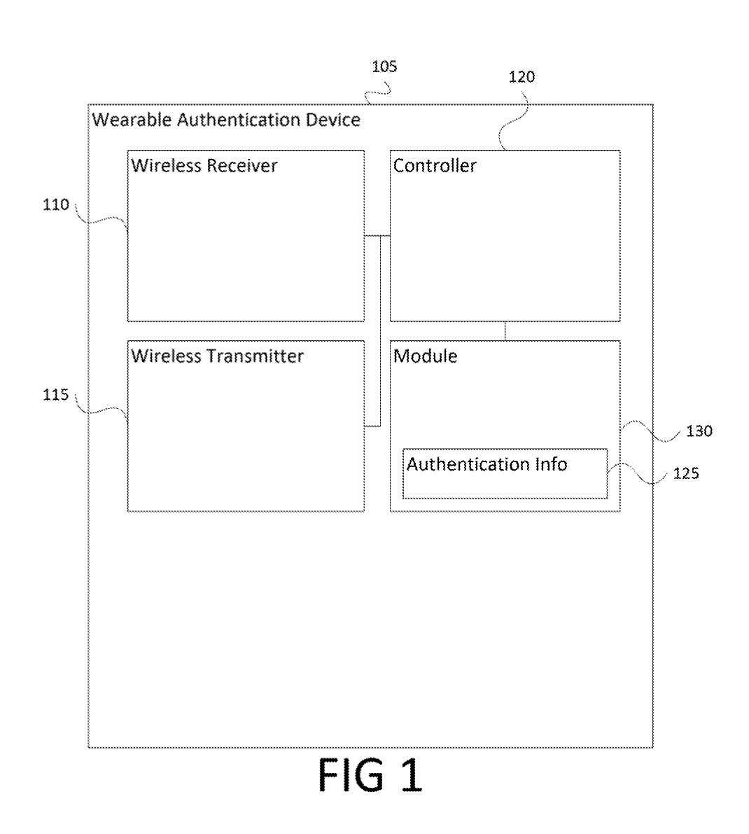

With reference to the figures, FIG. 1 is a block diagram of a wearable authentication device according to an example implementation. The wearable authentication device can include a wireless receiver 110. The wireless receiver may be a Bluetooth receiver, wifi receiver, near field receiver or another type of wireless receiver. The receiver may include or be connected to an antenna.

A module to store information indicating authentication has been established by first device. The first device may be a computer, a tablet, a phone, a kiosk, or another type of computing device. The module may be a storage device such as a flash storage, Random access memory or other volatile or non-volatile storage. The volatile storage would lose the authentication information when the power is lost such that if the power is lost the authentication data cannot be removed from the device and transferred to another authentication device as it will no longer be on the volatile storage. A non-volatile storage may retain the authentication data in the device so that the device does not have to be authenticated when the wearable authentication device is charged. The module may encrypt the authentication data to prevent the authentication data from being accessed. The encryption may be any type of encryption such as Advanced Encryption Standard (AES), RSA or other encryption types. The module may also be storage on a controller 120 which can including a flag, register or another type of module that could indicate the authentication of the wearable authentication device. In another implementation the module is preprogramed with the authentication information used to authenticate other devices and when the user authenticates to the first device the first device indicates to the wearable authentication device that it can transfer the authentication information stored in the module to a device requesting authentication such as a second device.

A wireless transmitter 115 can send information to a second device to establish authentication to the second device. A second device can receive the information transmitted from the wireless transmitter 115. The second device may be a computer, a tablet, a phone, a kiosk, or another type of computing device.

The controller 120 can store authentication information 125 in the module 130. The wearable authentication device may employ a public key infrastructure (PKI). The PKI can be used to establish a cryptographically trusted 2-way relationship between the wearable and another device. The wearable stores an encrypted digital certificate issued from the PKI provider along with other relevant information.

The wearable authentication device 105 may include cryptographic hardware that uses algorithms such as RSA and Digital Signature Algorithm (DSA), The wearable authentication device may generate key pairs on board, to avoid the risk from having more than one copy of the key. The authentication information may be generated by the wearable authentication device such as by the controller or another specialized logic. The generation of the authentication information may be generated from information received from the second device.

The authentication by the wearable authentication device may be used to log on to many different types of systems. For example the wearable may be used to log on to an intranet, virtual private network (VPN), a cloud service, a server, a client system or another type of system. The first device may include for example firmware, an application or an operating system that can communicate with the wearable authentication device and the authentication system of the system that is trying to authenticate the user. For example a cent device such as the first device may include a single sign on application that allows a user to input their password in one time and the application automatically logs them on to other services accessible from the client device such as an online email service. The single sign on application can also be enabled to communicate With the wearable authentication device to authenticate the wearable authentication device so that the user does not even have to enter there password and can use the wearable authentication device to authenticate the user to the single sign on application. The single sign on application may be on other client machines or may be a cloud service that would allow the wearable authentication device to authenticate the user to other devices enabled for use with the wearable authentication device.

When a user discontinues use of a device such as the first device then the first device may log the user off and the user would have to authenticate to the first device to use it which could be done with the wearable authentication device being in proximity to the device and having been previously authenticated. Discontinuing use of a device such as the first device may be determined in different ways for example the first device has not detected input for a set time period if the user is no longer detected within a threshold distance from the device.

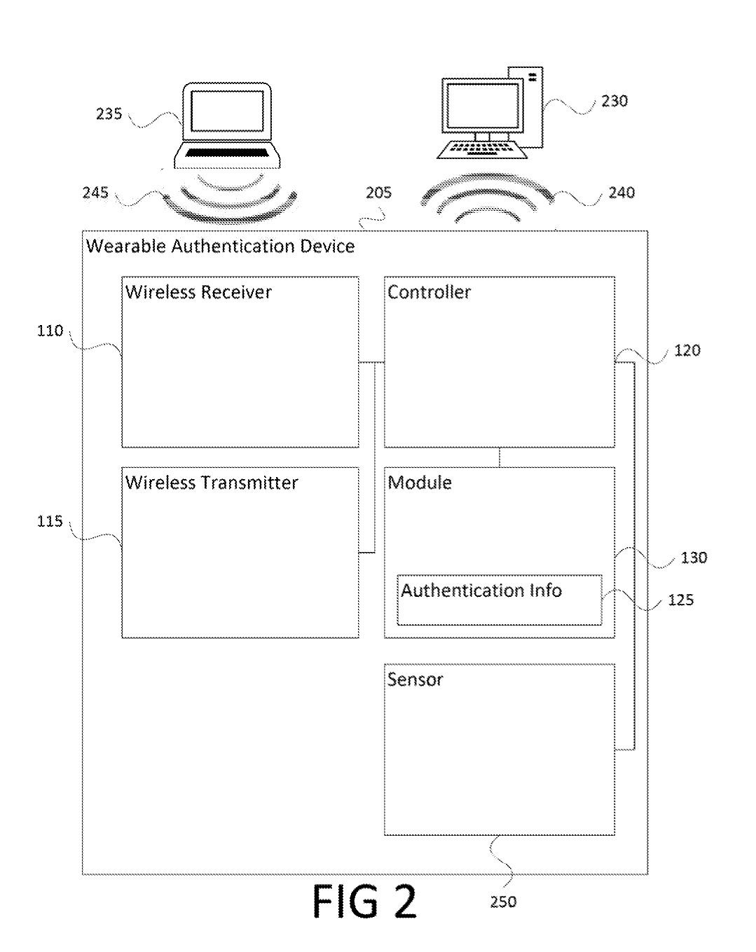

FIG. 2 is a block diagram of a wearable authentication device according to an example implementation. The wearable authentication device 205 can include a wireless receiver 110, a module 130 to store authentication information 125 indicating authentication has been established by first device 235. A sensor 250 can determine that the wearable authentication device 205 is being worn. The sensor 250 may be a capacitive sensor, microelectronic machine (MEM), proximity sensor, thermal sensor, heartbeat sensor, accelerometer or another type of sensor. The sensor may generate information that indicates that the wearable authentication device is in contact or otherwise attached to the user. If for example the sensor information indicates that the sensor is removed from the user the controller may not send authentication information to the second device 230.

When the wearable authentication device 205 is no longer being worn by the user the controller 120 can erase the information 125 indicating authentication from the first device 235. Erase may mean to clear or otherwise make the information inaccessible. In other Implementations the authentication information 125 may be tagged as invalid, the decryption key is erased, or other ways to prevent the authentication information from being used to authenticate the second device 230.

In another implementation the sensor may determine if a latch, clasp, fastener or other attachment system is opened or removed. For example if the wearable authentication device is a watch, bracelet, or belt for example and the band or buckle is opened the wearable authentication device may no longer authenticate to the second device.

A user may start the authentication process by first authenticating at the first device 235. The first device sends a wireless signal 245 to the wearable authentication device 205. The wireless receiver 110 of the wearable authentication device 205 receives the wireless signal 245. The wireless signal 245 can include information indicating that the user has authenticated themselves to the first device 235. The authentication can be through means such as passwords, biometrics such as fingerprints, retinal scans, or other biometrics or other types of authentication systems. The wearable authentication device can store authentication information 125. The authentication information 125 indicates that the user has authenticated to the first device 235.

When the user authenticates to the first device 205 the sensor is used to determine that the wearable authentication device is not removed from the user. This sensor may detect the user such as by capacitance, MEMs, proximity or the sensor may determine that the fastener to a user is not actuated such that is could be removed from a user.

In one implementation the user may authenticate to the first device but the first device may not send any authentication information to the wearable authentication device until the wearable authentication device has confirmed to the first device that the sensor is detecting a user or is closed. For example the wearable authentication device sensor can detects user using a capacitive sensor and the controller of the wearable authentication device can send through the wireless transmitter to the first device an indication that the wearable authentication device is in contact with a user. If the user were to input their authentication information into the first device without the first device receiving an indication that the wearable authentication device was in contact or attached to the user then the user may still use the first device but would not be able to use the wearable authentication device to authenticate a second device until the first device determines that the wearable authentication device is ready to be authenticated by the first device.

While the controller 120 determines from the sensor 250 that the wearable authentication device 205 is still in possession of the user the wearable authentication device 205 can send through the wireless transmitter 115 a signal 240 to the second device 230. Using the first device 235 allow the wearable authentication device 205 to be authenticated without use of a human computer interface such as a keypad or other input device. The lack of an input device on the wearable authentication device can allow the wearable authentication device to be made smaller and more efficient. For example a wearable authentication device may be a ring or bracelet without an input device. The power used to power a human computer interface is not needed which can allow the device to use a smaller capacity battery to achieve the same operating time as a larger battery used to also power a human computer interface. Without the human computer interface the power requirements may allow the wearable authentication device to be powered wirelessly for example when the wearable authentication device is within a threshold distance from the first device or the second device the device may receive power from the first device or second device in addition to exchanging authentication between the wearable authentication device and either the first or second device.

The controller 120 can determine from the information generated by the sensor 250 that the user may not be in control of the wearable authentication device 205. When it is determined that the wearable authentication device 205 may not be in contact with the user of the wearable authentication device 205 then the wearable authentication device 205 will not authenticate to the second device 230. When the sensor 250 indicates a change that could be the removal of the wearable authentication device such that it may not be worn by the user then the controller 120 may for example erase the information 125 indicating authentication from the first device 235.

In one implementation the described first device and the second device may be the same such that a user may use a desktop computer as the first device and authenticate to that device which authenticates the wearable authentication device and the user moves a threshold distance from the first device then the first device may log the user off the first device and the user would have to authenticate to the first device when the user returns. The wearable authentication device can be used to then authenticate the user to the desktop computer at which point the desktop computer would operate as the second device in the description of FIG. 2.

The wearable authentication device may also be able to determine bio feedback such as heart rate, blood glucose level, or other bio information. The wearable authentication device can communicate the bio information to a device such as the first device or second device.

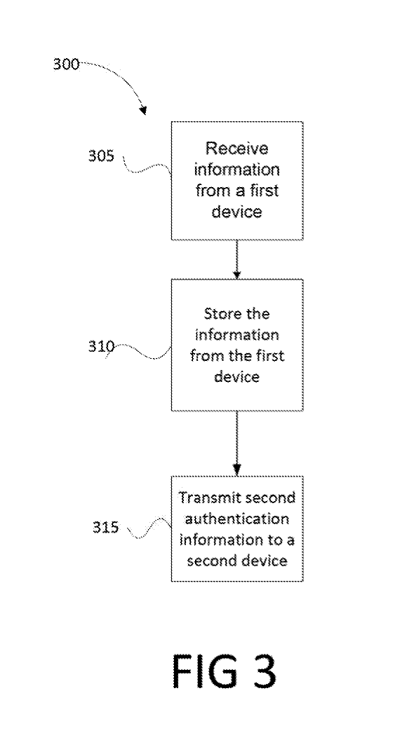

FIG. 3 is a flow diagram of a method of authenticating devices from a wearable according to an example implementation.

The method 300 of authenticating a computing device can include receiving by a wearable authentication device information from a first device at 305. The information from the first device can indicate the first device has authenticated a user with first authentication information.

The wearable authentication device can store the information from the first device at 310. The storage of the information can be in many different forms and on many different types of storage mediums. For example the information may be stored on a module such as module 130.

The wearable authentication device can transmit second authentication information to a second device authenticating the user to the second device when the information from the first device is stored at 315. The method 300 allows a user to authenticate themselves to the first device and carry a wearable authentication devices to authenticate themselves to a second device without providing the authentication information that was provided to the first device to the second device to authenticate the user to the second device.

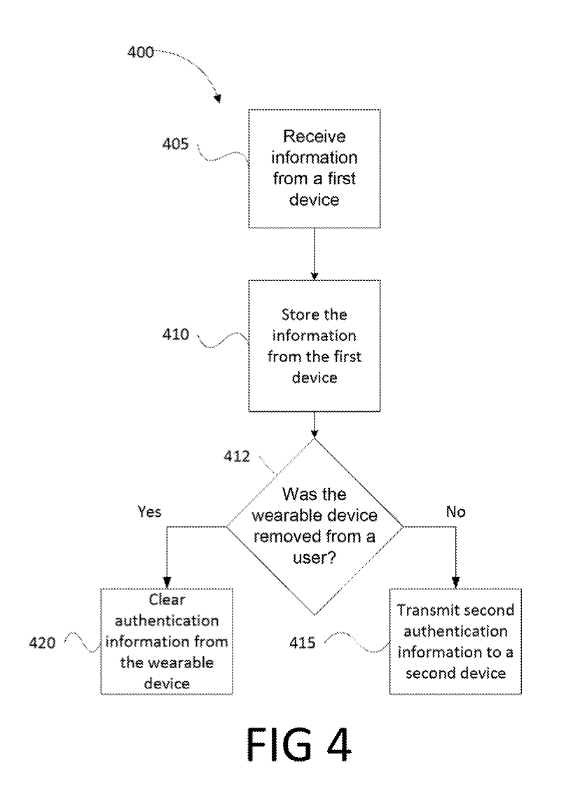

FIG. 4 is a flow diagram of a method of authenticating devices from a wearable according to an example implementation.

The method 400 for authenticating a computing device can include receiving by a wearable authentication device information from a first device at 406. The information from the first device can indicate the first device has authenticated a user with first authentication information.

The wearable authentication device can store the information from the first device at 410. The storage of the information can be in many different forms and on many different types of storage mediums. For example the information may be stored on a module such as module 130.

The wearable authentication device can detect the removal of the wearable authentication device from the user at 412. To detect the removal of the wearable authentication device from the user a sensor may be used such as the sensor 250. The sensor may generate information that can be used by the controller to determine that the wearable authentication device may have been removed from the user.

If it is determined at 412 that the wearable authentication device is not removed from the user then the method may proceed to 415. The wearable authentication device can transmit second authentication information to a second device authenticating the user to the second device when the information from the first device is stored at 415.

If it is determined at 412 that the wearable authentication device is removed from the user then the method may proceed to 420. The authentication information indicating that the wearable authentication device had been authenticated by the first device can be erased, such as cleared, when the wearable authentication device is removed from the user at 420.

The method 400 allows a user to authenticate themselves to the first device and carry a wearable authentication devices to authenticate themselves to a second device without providing the authentication information that was provided to the first device to the second device to authenticate the user to the second device.

The information received from the first device can be different from the first authentication information used to authenticate the user to the first device. For example the first device may receive a password or biometric information but that information is not sent to the wearable authentication device. The information sent to the wearable authentication device from the first device may be derived from the authentication information received by the first device from the user or may be generated by the first device. The authentication information sent by the first device may be linked to the user s account that was authenticated by the first device. For example a user may have an account that can accessed by the first device the account may have a user name or other identifier to identify the user account.

The second authentication information transmitted to the second device can different than the first authentication information. For example the authentication information such as passwords or biometric information is not transmitted to the second device from the wearable authentication device.

The example implementations could be used as with other authentication systems and methods. For example the authentication methods may be used as a second level authentication such as the wearable authentication device may be used as one level of authentication to a second device while the second device also accepts other authentication systems and methods that have to be entered by the use to log on to the second deice such as a password, biometrics or other systems.

The techniques described above may be embodied in a computer-readable medium for configuring a computing system to execute the method. The computer readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc, and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

The use of “comprising° , ° including” or “having” are synonymous and variations thereof herein are meant to be inclusive or open-ended and do not exclude additional unrecited elements or method steps. It should also be noted that a plurality of hardware and software based devices, as well as a plurality of different structural components may be used to implement the disclosed methods and systems.

In the foregoing description, numerous details are set forth to provide an understanding of the present disclosure. However, it will be understood by those skilled in the art that the present disclosure may be practiced without these details. While the disclosure has been disclosed with respect to a limited number of embodiments, those skilled in the art will appreciate numerous modifications and variations therefrom. It is intended that the appended claims cover such modifications and variations as fall within the true spirit and scope of the disclosure.

What is claimed is:

1. A wearable authentication device comprising:
a wireless receiver;
a module to store information indicating authentication has been established by first device; and
a wireless transmitter to send information to a second device establishing authentication.

2. The device of claim 1, further comprising 1 sensor to determine that the wearable authentication device is being worn.

3. The device of claim 2, further comprising a controller to erase the information indicating authentication from the first device.

4. The device of claim 3, wherein the controller is to erase the information indicating authentication from the first device when the sensor determines the wearable authentication device is not being worn.

5. The device of claim 2, wherein the sensor generates information indicating removal of the wearable device.

6. A wearable authentication device comprising:
a wireless receiver;
a module to store information indicating authentication has been established by first device; and
a sensor to determine that the wearable authentication device is being worn.

7. The device of claim 6, further comprising a wireless transmitter to send information to a second device establishing authentication.

8. The device of claim 6, further comprising a controller to erase the information indicating authentication from the first device.

9. The device of claim 8, wherein the controller is to erase the information indicating authentication from the first device when the sensor determines the wearable authentication device is not being worn.

10. The device of claim 6, wherein sensor generates information indicating removal of the wearable device. 11, A method of authenticating a computing device comprising;
receiving by a wearable authentication device information from a first device indicating the first device has authenticated a use with first authentication information;
storing the information from the first device; and
transmitting second authentication information to a second device authenticating the user to the second device when the information from the first device is stored.

12. The method of claim 11, wherein the information received from the first device is different from the first authentication information used to authenticate the user to the first device.

13. The method of claim 11, wherein the second authentication information transmitted to the second device is different than the first authentication information.

14. The method of claim 11, further comprising detecting removal of the wearable authentication device from a user.

15. The method of c aim 14, further comprising clearing authentication information from the wearable authentication device when it is detected that the wearable authentication device has been removed from the user.
